(19) United States
(12) Patent Application Publication
(10) Pub. No.: US 2023/0017439 A1
(43) Pub. Date: Jan. 19, 2023

(54) PRESERVATION OF NUCLEIC ACID SEQUENCES BY FIXING TISSUES IN BUFFERED FORMALIN PREPARED WITH ACID-DEPRIVED FORMALDEHYDE

(71) Applicant: ADDAX BIOSCIENCES S.R.L., Torino (IT)

(72) Inventors: Giovanni Bussolati, Torino (IT); Benedetta Bussolati, Torino (IT); Nicolo' Bussolati, Torino (IT)

(73) Assignee: ADDAX BIOSCIENCES S.R.L., Torino (IT)

(21) Appl. No.: 17/757,463

(22) PCT Filed: Dec. 15, 2020
(86) PCT No.: PCT/EP2020/086247

§ 371 Date: Jun. 16, 2022

(30) Foreign Application Priority Data
Dec. 18, 2019 (IT) 102019000024448

(51) Int. Cl. G01N 1/30; A01N 1/02

(52) U.S. Cl. CPC G01N 1/30; A01N 1/021; G01N 2001/305

(57) ABSTRACT

The invention relates to a method of preservation of nucleic acid sequences in histological tissues which comprises: treating a concentrated formaldehyde solution in water with basic ion-exchange resins; diluting the resulting acid-deprived formaldehyde solution with phosphate buffer pH 7.2-7.4 up to a concentration ranging between 2 and 4%; contacting the resulting acid-deprived formaldehyde solution obtained with the tissue samples; optionally embedding the samples fixed in paraffin.

The present invention aims at suggesting an approach designed to improve the genetic integrity of organic tissue samples fixed with formalin.

### PRIOR ART

The preservation and fixation of histological tissues is currently performed by immersion in an aqueous solution containing formic aldehyde, in particular a solution containing 4% formic aldehyde in water, known as formalin. Formalin is very widely used, not only for fixation of leather and hides but also, in the medical field, for the purpose of tissue transport, for preservation (e.g. in museums), and for the fixation that necessarily precedes embedding in paraffin, dissection and staining of histological preparations, for the purpose of microscopic examination prior to diagnosis (Fox et al., 1985). In recent times, biopsy material fixed in formalin and embedded in paraffin (Formalin-Fixed Paraffin-Embedded=FFPE) has been studied not only morphologically, on sections stained with haematoxylin-eosin and using immunohistochemical analysis, but also with molecular biology analysis and gene sequencing. Genetic tumour alterations are determined in order to facilitate treatment selection and prognosis. In routine clinical practice, targeted sequencing analysis is therefore performed with formalin-fixed paraffin-embedded tissues (FFPE). However, successful genetic analysis remains difficult because the DNA of FFPE biopsies tends to fragment during the sample preparation process.

Formalin-fixed paraffin-embedded (FFPE) tissues are regularly prepared and used for pathological diagnosis of various disorders, and a large amount of archival FFPE tissue is stored and archived in pathology departments (according to Italian law, tissue must be stored for at least 10-20 years because further analyses useful to the patient could potentially be required). FFPE tissue can easily be stored at room temperature for long periods of time and analysed retrospectively. Although formalin is a widely used fixation reagent, it has an adverse effect on the integrity of DNA and generates DNA-DNA and/or DNA-protein crosslinks, nucleotide transitions and DNA fragmentation. Said effects can interfere with subsequent analyses of the sample, such as the Next Generation Sequencing (NGS) technique. Although sequencing can also be used to analyse DNA fragments, and techniques have been devised to determine the presence of mutations on said fragments, badly fragmented DNA cannot be used to prepare an NGS library (Amemia et al., 2019). Recently, NGS analysis has often been conducted on DNA extracted from FFPE tissues. These genetic approaches have clarified new molecular subtypes in multiple disorders, including tumours, and have changed the clinical practice by establishing precision techniques.

Large amounts of FFPE tissue have been stored in archives in clinics, hospitals and academic institutions worldwide. However, the DNA extracted from FFPE tissue is often fragmented, and exhibits cytosine to thymidine transitions and crosslinking modifications. Said changes mainly depend on the fixation time, the concentration of the formalin reagents, and storage conditions. DNA from low-quality (fragmented) FFPE is unsuitable for genetic analysis and can generate artefacts. Numerous studies have examined how DNA quality and the consequent success rate of NGS analysis is influenced by the types of fixative reagents used and the fixing times. The quality (i.e. the degree of fragmentation) of the DNA and RNA of FFPE tissue is mainly determined by fixation in formalin, and neutral buffered formalin (PBF) is preferable to acidic formalins for fixation of paraffin-embedded samples, so as to obtain a high success rate in targeted analysis sequencing. For example, variations in pH associated with storage time are known to give rise to oxidation of formalin to formic acid, causing alterations of the nitrogenous bases and sequence breaks (Groelz et al., 2013). Significant degradation of DNA extracted from the same FFPE block has also been observed after 4-6 years' storage. Better storage strategies for the preservation of FFPE biopsy samples should therefore be considered (Guyard et al., 2017).

The possibility of obtaining high-quality mRNA from archival tissue may pave the way for broader analysis of the gene expression profile than is currently feasible (Scicchitano et al., 2006; Abramovitz et al., 2008) and enable the clinical behaviour and therapeutic response of individual malignant tumours to be predicted, thus making customised treatments possible. At present, this approach requires harvesting of frozen samples, a cumbersome procedure that is not always possible. The use of FFPE tissue for gene expression profiling would make the widespread use of this molecular approach possible and easy, even with archival tissue subjected to long-term preservation in paraffin.

The treatment of tissues (biopsies and surgical samples for histopathological diagnosis) in 4% formaldehyde in water with 0.1 M phosphate buffer pH 7.2 (formalin) is known. Several million specimens have been treated worldwide in this way. Such fixation is generally conducted by immersing tissue samples in formalin for a period ranging between several hours and 24 hours. This is commonly done at room temperature. The use of a treatment with cold formalin, which leads to better preservation of DNA and RNA, has been reported (Bussolati et. al, 2011). In recent times, demand for nucleic acid sequencing from formalin-fixed paraffin-embedded tissues (FFPE) has increased greatly, because the exploitation of the huge tissue archives would thus include evaluation of the gene expression profile, with the aim of generating new and reliable diagnostic and prognostic parameters, in particular for cancer (Madeiros et al., 2007; Lewis et al., 2001). Numerous studies have been conducted on the state of preservation of nucleic acids in FFPE tissues, but there is substantial general agreement that RNA has been found to be strongly degraded and fragmented, so that only fairly short sequences (of around 100-200 nucleotides) can be recognised and amplified (Chung et. Al., 2006; Dotti, 2010; van Maldeghem, 2008; Paska, 2004; Masuda). The reasons for this effect are currently unknown. Requests for gene expression profiling in order to establish the prognostic and therapeutic prospects in pathological lesions of individual patients are pressing, because the prospects are very promising, especially in breast, lung and colon cancer. At present, the only possible approach is to harvest frozen samples (in tissue banks) and store said material, so that it can be processed for gene expression analysis. It has been observed that immersion in formalin at room temperature for 24 hours, or at least for several hours, as usually recommended and practised (Goldstein et al., 2003: Goldstein et al., 2007), leads to optimum morphological and antigen preservation; the use of FFPE tissue also for gene sequencing would therefore open up significant prospects and allow the exploitation of the huge archives present worldwide (see Chen et al, 2007; Scicchitano et al., 2006; Abramovitz et al., 2008). Gene sequencing techniques such as DNA microarrays obtained from tissues, and two-dimensional gel electrophoresis, have been successfully used to provide information about genes, proteins, metabolites and other molecular characteristics correlated with specific pathological conditions. Several new genes and the products thereof have been identified in human tumours by screening archival tissue samples, i.e. FFPV tissues. The diagnostic molecular test is most often required under certain clinical conditions, such as clonality tests of the T or B cells in early-stage skin lymphomas, and the need for examination of molecular pathology tests to reach a definitive clinical diagnosis can be expected to increase in future (Srinivasan et al., 2002).

As the preservation of nucleic acids is therefore necessary to ensure the validity of their molecular examination, the fixation and preservation conditions of biopsy samples are a critical factor. The characteristics of the aldehyde fixative are therefore of crucial importance. Acid fixatives, like the presence of formic acid, cause fragmentation of the DNA and RNA chains (Koshiba et al, 1993; Srinivasan et al., 2002). It is therefore currently recommended that tissues should be fixed in a 4% formaldehyde solution obtained by diluting 40% saturated commercial formaldehyde 1:10 in phosphate buffer pH 7.2-7.4 (Phosphate-Buffered Formalin=PBF). Commercial 40% formaldehyde solutions are strongly acidic (pH 2-3) because of the presence of formic acid (Fox et al., 1985), which is responsible for the fragmentation of nucleic acids (Srinivasan et al., 2002).

In some commercial preparations, calcium carbonate is added to the 40% formaldehyde solution. Formic acid is present in the PBF solution, but is destined to be neutralised in the form of sodium formate.

### DESCRIPTION OF THE INVENTION

The purpose of the invention is therefore to propose an approach designed to improve the genetic integrity of organic tissue samples fixed with formalin, since the fixation with PFB currently in use gives disappointing results, as described above.

It has now been discovered that when the commercial formaldehyde solution is deprived of acids using ion-exchange resins, thereby eliminating the formation of sodium formate, fixation in the resulting acid-free reagent (Acid-Deprived, Phosphate-Buffered Formalin=AD-PBF) gives rise to better preservation and lower fragmentation of nucleic acids, especially DNA, than is the case when commercial phosphate-buffered formalin-fixed tissues (PBF) are used. The improvement was markedly significant in AD-PBF-fixed paraffin-embedded tissues stored for a long time.

The subject of the invention is therefore a preservation method for nucleic acid sequences in histological tissues and cytological samples which comprises:
a. treating a concentrated solution of formaldehyde in water with basic ion-exchange resins;
b. diluting the acid-deprived formaldehyde solution obtained from step a) with phosphate buffer pH 7.2-7.4 to a concentration ranging between 2 and 4%, preferably to a concentration of 4%;
c. placing the acid-deprived formaldehyde solution obtained from step b) in contact with the tissue samples;
d. optionally embedding the fixed samples from step c) in paraffin. The concentrated formaldehyde solution used in step a) is available on the market, and has a concentration ranging between 30 and 40% by weight.

Any basic resin able to neutralise the acids present in the formaldehyde solution and prevent their formation can be used as ion-exchange resin. An example of a resin suitable for said purpose is Amberlyst A21® resin.

Histological and cytological samples are typically treated with the acid-deprived formaldehyde solution for a time ranging between 3 and 72 hours.

The following examples illustrate the invention in greater detail.

### Example 1

40% formaldehyde solutions were obtained on the market (Sigma-Aldrich, Milan; Carlo Erba, Milan). The pH of said solutions ranged between 2.6 and 2.9. Amberlyst resin A21 (Dow Chemicals, Milan), a basic ion-exchange resin, was washed with H2O, after which 10 g of said resin was added to 100 ml of 40% formaldehyde. Said mixture was stirred for 60 min. at room temp., and then filtered. The pH of the filtrate ranged between 6.8 and 7.3. The filtrate was mixed at the ratio of 1:10 in phosphate buffer pH 7.2, and an acid-deprived 4% formaldehyde solution in phosphate buffer (AD-PBF) was obtained.

Fresh human tissues (kidney, liver, colon, colon carcinoma and breast carcinoma), destined for disposal because they were superfluous to diagnostic requirements, were used for fixation. Adjacent sections of tissue fragments were fixed in AD-PBF (see above) and commercial buffered formalin (DiaPath, Bergamo). The tissues remained in their respective fixatives for 20 hours at room temp., and were then processed for embedding in paraffin (Leica embedding apparatus: Leica ASP 300 S).

The paraffin-embedded tissue blocks were cut to obtain sections stained with haematoxylin-eosin. For the extraction, quantitation and evaluation of DNA and RNA quality, nine sections (thickness 5 μm) were obtained from paraffin-embedded tissue blocks of 10 tissues (see above) fixed in parallel in AD-PBF and PBF. The sections were deparaffinised with 1 ml of xylene. After overnight incubation at 56° C. with proteinase K, the DNA was isolated from five sections using the MagCore Genomic DNA FFPE kit on the MagCore automatic extraction instrument (RBC Bioscience, Taiwan), according to the manufacturer's protocol. The RNA was obtained by using the remaining four sections with the RecoverAll total nucleic acid isolation kit for FFPE (ThermoFisher Scientific, USA), according to the manufacturer's protocols. Both DNA and RNA extracts were quantified by Qubit BR assay on a Qubit Fluorometer (Invitrogen, Carlsbad, Calif., USA) and NanoDrop Spectrophotometer (ThermoFisher Scientific). DNA and RNA integrity was evaluated with the Agilent 2100 Bioanalyzer (Agilent Technologies, USA).

DNA integrity was evaluated with the high-sensitivity DNA analysis kit (Agilent Technologies, Santa Clara, Calif.) on DNA HS chips. The samples were diluted to 2 ng/μL, and DNA length analysis was conducted according to the manufacturer's instructions. The average size of the DNA fragment of the AD-PBF and PBF samples was evaluated using 5000 nt as threshold for the longest DNA fragments (>5000 nt). Their distribution relative to said threshold was compared statistically with the Chi-square test.

RNA integrity was evaluated with the Agilent RNA 6000 nano kit. The size distribution of the DNA fragments was calculated from the readings of the Agilent 2100 Bioanalyzer, using smear analysis with a threshold of 200 nt; the percentage of DNA fragments with a size >200 nt (DV200 metric) was recorded.

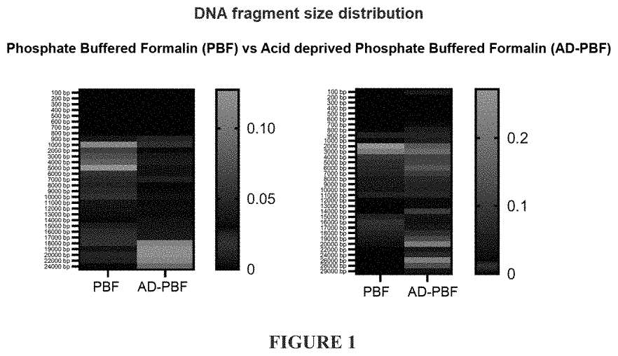

FIG. 1 compares the DNA extracted from tissue fixed in PBF or AD-PBF. Biopsies obtained in parallel from the same colon (left) and breast (right) carcinoma sample were fixed in PBF or AD-PBF, and the DNA extracted was analysed with the Agilent Bioanalyzer. The image shows the size of the DNA fragments obtainable in decreasing order (colour intensity scale as shown in the sidebar). The presence of DNA of larger size, and therefore less fragmented, is evident in the biopsies fixed with AD-PBF.

As shown in FIG. 1, in tissues fixed in PBF, the size of the vast majority of the DNA fragments obtainable (by analogy with the findings described in the literature) ranges between 1000 and 5000 bp, indicating intense fragmentation. Conversely, fixation in AD-PBF, and therefore removal of acid radicals from the fixative, gives rise to fragments which are much better preserved up to 20,000 bp.

### Example 2

Tissues fixed in AD-PBF and, in parallel, in PBF and embedded in paraffin, were stored at room temperature for 12 months, after which the analysis procedure of Example 1 was repeated.

The DNA extracted from the tissues was analysed with the Agilent Bioanalyzer apparatus.

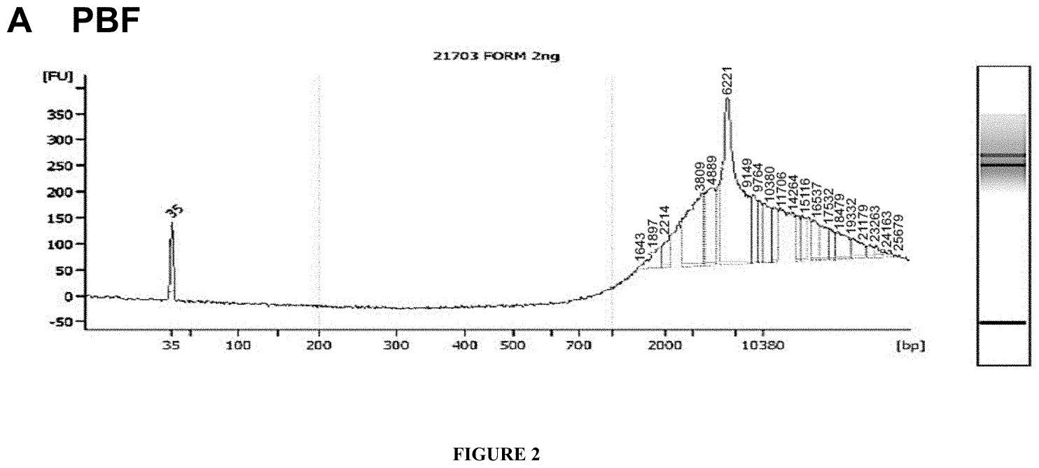

FIG. 2 shows the DNA extracted from the same colon carcinoma sample fixed in PBF or AD-PBF, embedded in paraffin, and stored for a year. The extracted DNA was analysed with the Agilent Bioanalyzer. The curves show the size of the DNA fragments obtainable as the size increases. The fact that longer DNA fragments were present in the biopsies fixed with AD-PBF (B) than in those fixed with PBF (A) clearly appears.

### Example 3

In order to check the preservation of nucleic acids, and specifically of DNA, in tissues fixed alternatively in Phosphate buffered Formalin and in AD Formalin, a study was conducted in 27 cases of human cancers (colon, breast and lung cancers). Specimens (approximate size: 1×2×0.3 cm) were collected fresh from the tissues and fixed in parallel in Acid-Deprived (A-D) Formalin, buffered at pH 7.2 with Phosphate Buffer 0.1 M and in a Phosphate buffered Formalin (PBF) from the commerce (Roti-Histofix 4.5 acid free (pH 7) phosphate-buffered formaldehyde solution, Prodotti Gianni, Milan, Italy). The specimens were immersed in the alternative fixatives for 24 h., at room temp., then processed routinely for paraffin embedding.

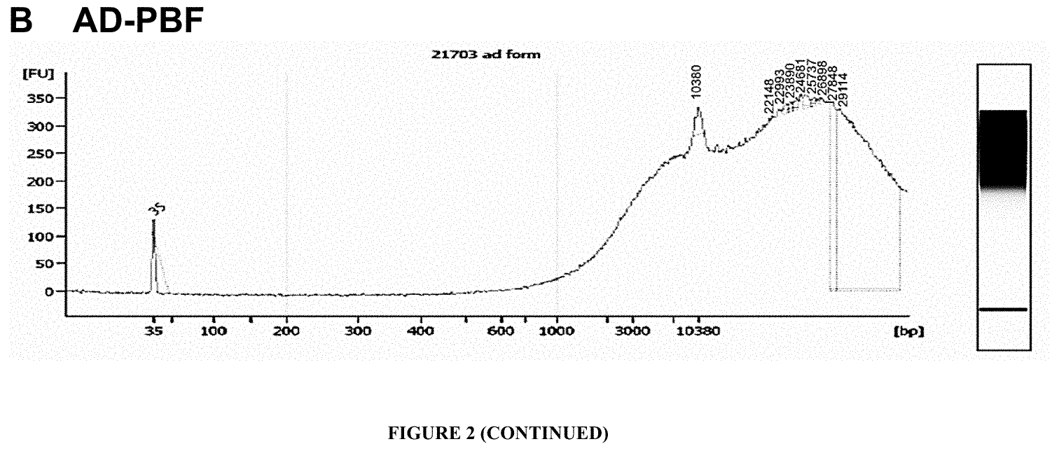

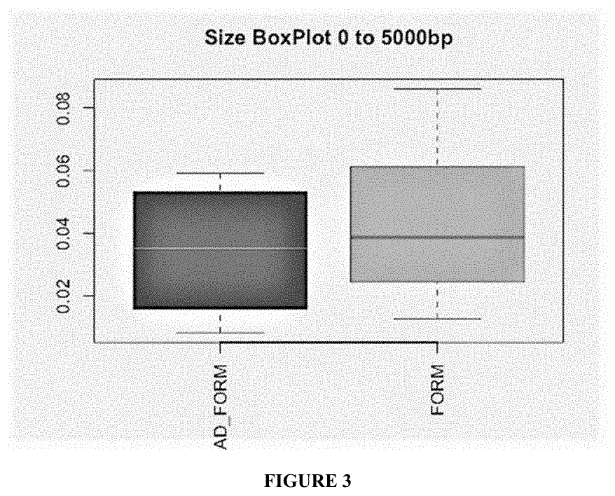

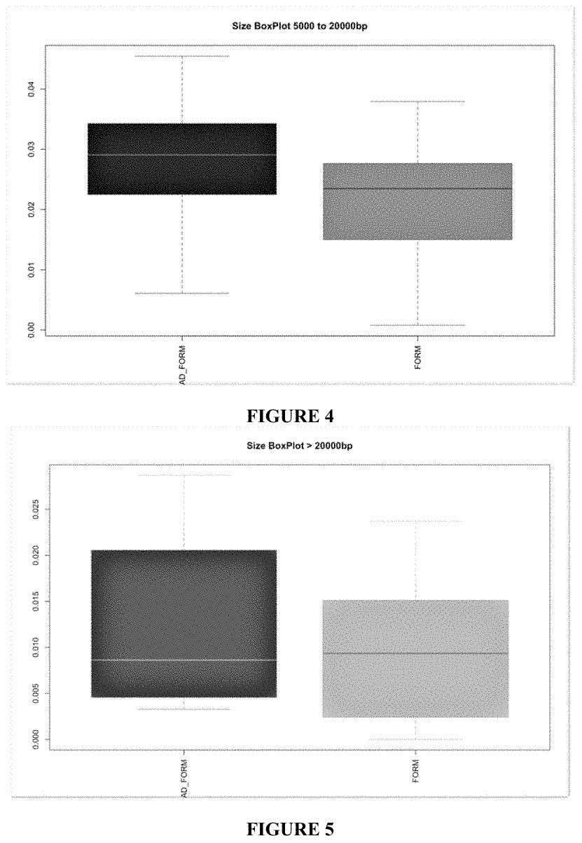

Section from the paraffin blocks (10 sections, 5 micron thick) were processed for DNA extraction, then analyzed for assessing the size of the fragments, matching in each case the size of base-pair fragments. The direct comparison was represented either in lines (matching size vs frequency) and using the Kolmogorv-smirnoff test to evaluate the lines tendency or, alternatively, Box plots (see FIGS. 3-5) featured in 3 different families of base-pair fragments (0-5000, 5000-20000, >20000). The data were statistically analyzed with paired tests.

The results clearly indicate that tissue fixation in PBF results in a higher fragmentation of DNA, since in tissues fixed in AD Formalin there is a higher number of fragments longer than 5000 bp. The data indicate that tissues fixed in AD Formalin are more fit for a successful DNA analysis of tumor tissues, permitting a more proper definition of the theragnostic features.

### BIBLIOGRAPHY

Amemiya K et al., Relationship between formalin reagent and success rate of targeted sequencing analysis using formalin fixed paraffin embedded tissues. Clinica Chimica Acta 488, 2019, Pages 129-134.
Bussolati G. Et al., Formalin fixation at low temperature better preserves nucleic acid integrity. PLoS One. 2011; 6(6):e21043.
Dotti et al., “Effects of formalin, methacarn, and fineF1X fixatives on RNA preservation,” Diagn Mot Pathol, vol. 19, No. 2, June 2010, pp. 112-122. Fox et al., “Formaldehyde fixation,” Journal of Histochemistry & Cytochemistry, 33, 845-853, 1985.
Goldstein et al., “Minimum Formalin Fixation Time for Consistent Estrogen Receptor Immunohistochemical Staining of Invasive Breast Carcinoma,” American Journal of Clinical Pathology, 2003, vol. 120, pp. 86-92.
Goldstein et al., “Recommendations for improved standardization of immunohistochemistry,” Appl Immunohistochem Mot Morphol. June 2007, vol. 15, No. 2, pp. 124-133.
Groelz D, Sobin L, Branton P, Compton C, Wyrich R, Rainen L. Exp Mol Pathol. 2013; 94: 188-19.
Hewitt et al., “Tissue handling and specimen preparation in surgical pathology: issues concerning the recovery of nucleic acids from formalin-fixed, paraffin-embedded tissue,” Archives of pathology & laboratory medicine. December 2008, vol. 132, pp. 1929-1935.
Koshiba M, Ogawa K, Hamazaki S, Sugiyama T, Ogawa O, Kitajima T. The effect of formalin fixation on DNA and the extraction of high-molecular-weight DNA from fixed and embedded tissues. Pathol Res Pract. 1993 February; 189(1):66-72.
Lewis et al., “Unlocking the archive gene expression in paraffin-embedded tissue,” The Journal of pathology, copyright 2001, John Wiley & Sons, Ltd. 195, pp. 66-71.
Masuda et al., “Analysis of chemical modification of RNA from formalin-fixed samples and optimization of molecular biology applications for such samples,” Oxford University Press, Nucleic Acids Research, 1999, vol. 27, No. 22, pp. 4436-4443.
Medeiros et al., “Tissue Handling for Genome-Wide Expression Analysis: A Review of the Issues, Evidence, and Opportunities,” Archives of Pathology & Laboratory Medicine. December 2007, vol. 131, pp. 1805-1816
Paska et al., “Effect of formalin, acetone, and RNAlater fixatives on tissue preservation and different size amplicons by real-time PCR from paraffin-embedded tissue,” Diagn Mot Pathol, December 2004, vol. 13, No. 4, pp. 234-240.
Scicchitano et al., Preliminary Comparison of Quantity, Quality, and Microarray Performance of RNA Extracted from Formalin-fixed, Paraffin-embedded, and Unifixed Frozen Tissue Samples, Journal of Histochemistry & Cytochemistry, 2006, vol. 54, pp. 1229-1237.
Srinivasan M. et al., Effect of Fixatives and Tissue Processing on the Content and Integrity of Nucleic Acids. American Journal of Pathology, Vol. 161, 1961-1971, 2002.
Stanta et al., “RNA extracted from paraffin-embedded human tissues is amenable to analysis by PCR amplification,” 304 BioTechniques, 1991, vol. 11: No. 3, 3 pages.
van Maldegem et al., “Effects of processing delay, formalin fixation, and immunohistochemistry on RNA Recovery From Formalin-fixed Paraffin-embedded Tissue Sections,” Diagn Mot Pathol. March 2008, vol. 17, No. 1, pp. 51-58.

1. A method of preservation of nucleic acid sequences in histological tissues which comprises:
a) treating a concentrated formaldehyde solution in water with basic ion-exchange resins;
b) diluting the acid-deprived formaldehyde solution obtained from step a) with phosphate buffer pH 7.2-7.4 up to a concentration ranging between 2 and 4%;
c) contacting the acid-deprived formaldehyde solution obtained from step b) with the tissue samples;
d) optionally embedding the samples fixed in step c) in paraffin.

2. A method according to claim 1, wherein the concentrated formaldehyde solution has a concentration of 40% by weight.

3. A method according to claim 1, wherein the concentration of the acid-deprived formaldehyde solution is 4% by weight.

4. A method according to claim 1, wherein the ion-exchange resin is an Amberlyst A21 resin.

5. A method according to claim 1, wherein the samples are treated with the acid-deprived formaldehyde solution for a time ranging between 3 and 72 hours.

6. Method of fixing histological and cytological samples, said method comprising
contacting a tissue sample with a 4% by weight acid-deprived formaldehyde solution in phosphate buffer pH 7.2, and
fixing said tissue sample.

7. The method according to claim 6, wherein said tissue sample is DNA or RNA.

8. A method of analyzing DNA or RNA, said method comprising
contacting said DNA or said RNA with a 4% by weight acid-deprived formaldehyde solution in phosphate buffer pH 7.2.
